(19) United States
(12) Patent Application Publication
(10) Pub. No.: US 2013/0331114 A1
(43) Pub. Date: Dec. 12, 2013

(54) ADJACENT NETWORK AWARE SELF ORGANIZING NETWORK SYSTEM

(71) Applicant: Eden Rock Communications, LLC, Bothell, WA (US)

(72) Inventors: Eamonn GORMLEY, Bothell, WA (US); Chaz IMMENDORF, Bothell, WA (US)

(21) Appl. No.: 13/912,091

(22) Filed: Jun. 6, 2013

Related U.S. Application Data
(60) Provisional application No. 61/656,474, filed on Jun. 6, 2012.

(51) Int. Cl. H04W 72/08

(52) U.S. Cl. CPC H04W 72/082
USPC 455/452.1

(57) ABSTRACT

A network resource device is associated with a first wireless network that is configured to provide wireless services in a first geographic area. The network resource device comprises a processor and a non-transitory computer readable medium with computer executable instructions stored thereon which, when executed by the processor, perform the following method: obtaining performance metrics data of a second wireless network, the second wireless network being configured to provide wireless communication services in a second geographic area that overlaps with the first geographic area; and changing a configuration parameter associated with the first wireless network based on the second performance data obtained in order to reduce interference generated by the first wireless network towards the second wireless network.

### CROSS-REFERENCES TO RELATED APPLICATIONS

The present invention claims priority to and is a non-provisional of U.S. Application No. 61/656,474, filed Jun. 6, 2012, which incorporated by reference for all purposes.

### BACKGROUND

The single greatest challenge for wireless operators today is keeping pace with the rapidly growing consumer demand for increased wireless broadband data rates. These challenges have been exacerbated by the growing mainstream adoption of smart phones and the desire for greater ‘cloud’ connectivity of laptops, tablets, and other mobile devices.

Network operators are responding to this explosive growth by investing billions of dollars into building out of 4G networks, evolving to heterogeneous networks, improving network utilization, and adopting new service paradigms. However, network operators face daunting tasks in trying to meet the exploding demands for wireless communication bandwidth since the available frequency bandwidths are fixed. Network operators need to find a way to use the allocated bandwidths more efficiently.

### BRIEF SUMMARY

Embodiments of the present disclosure relates to a networked computing system having self-organizing network (SON) capabilities. Based on the performance metrics of another wireless network, the SON processes change parameters of its wireless network so that interference generated by its wireless network towards another wireless network is reduced. Parameters of the first wireless network that may be changed include: bulk transmit power of radio transmitters, transmit power settings of individual radio resources (e.g., transmit power of a wireless sub band, or transmit power used on different timeslots or on different radio codes, pointing direction of remotely controlled antennas (e.g., antennas with remote electrical tilt (RET), remote azimuth steering (RAS) or remote azimuth beam width (RAB) capabilities), and the like. In embodiment, the SON processes optionally communicates recommended parameter changes to a Network Resource Controller (NRC) of the second wireless network.

In an embodiment, a network resource device is associated with a first wireless network that is configured to provide wireless services in a first geographic area. The network resource device comprises a processor and a non-transitory computer readable medium with computer executable instructions stored thereon which, when executed by the processor, perform the following method: obtaining performance metrics data of a second wireless network, the second wireless network being configured to provide wireless communication services in a second geographic area that overlaps with the first geographic area; and changing a configuration parameter associated with the first wireless network based on the second performance data obtained in order to reduce interference generated by the first wireless network towards the second wireless network.

In an embodiment, a method for reducing interference in a wireless network includes accessing configuration parameters of a first wireless network by a network resource device associated with the first wireless network, the first wireless network being configured to provide wireless communication services in a first geographic area. Performance metrics data of a second wireless network is obtained by the network resource device, the second wireless network being configured to provide wireless communication services in a second geographic area that overlaps with the first geographic area. A configuration parameter associated with the first wireless network is changed by the network resource device based on the performance metrics data of the second wireless network in order to reduce interference generated by the first wireless network towards the second wireless network.

In another embodiment, a networked computing system includes a first wireless network having a plurality of base stations, the first wireless network being configured to provide wireless services in a first geographic coverage area that overlaps with a second geographic coverage area of a second wireless network. A network resource device is associated with the first wireless network. A non-transitory computer readable medium is provided in an element in the first wireless network, the non-transitory computer readable medium having computer executable instructions stored thereon which, when executed by the processor, perform the following method: accessing configuration parameters associated with the first wireless network; and changing a configuration parameter associated with the first wireless network based on performance metrics data of the second wireless network in order to reduce interference generated by the first wireless network towards the second wireless network.

### BRIEF DESCRIPTION OF THE DRAWINGS

In the detailed description that follows, embodiments are described as illustrations only since various changes and modifications will become apparent to those skilled in the art from the following detailed description.

FIG. 1 illustrates a networked computing system according to an embodiment of this disclosure.

FIG. 2 illustrates an exemplary block diagram of a base station (e.g., a femtocell, picocell, microcell or macrocell).

FIG. 3 illustrates an exemplary block diagram of a server computer.

FIG. 4 illustrates an exemplary block diagram of a mobile station.

FIG. 5 illustrates first and second networked computer systems includes a first wireless network and a second wireless network, respectively, according to an embodiment.

FIG. 6 illustrates an exemplary SON controller.

FIG. 7 illustrates a process for reducing interference between the first and second wireless networks and having overlapping geographic coverage areas according to an embodiment.

FIG. 8 illustrates a process for reducing interference between the first and second wireless networks and having overlapping geographic coverage areas according to an embodiment.

### DETAILED DESCRIPTION

In the following detailed description, reference is made to the accompanying drawings, which form a part of the description. The example embodiments described in the detailed description, drawings, and claims are not meant to be limiting. Other embodiments may be utilized, and other changes may be made, without departing from the spirit or scope of the subject matter presented herein. It will be understood that the aspects of the present disclosure, as generally described herein and illustrated in the drawings, may be arranged, substituted, combined, separated, and designed in a wide variety of different configurations.

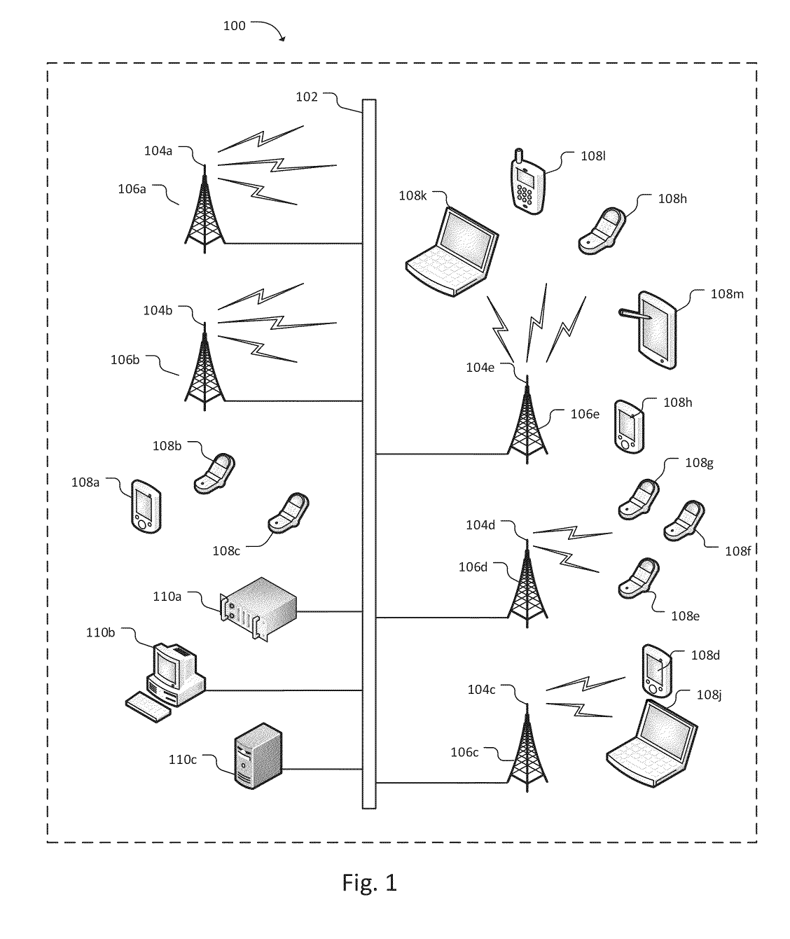

FIG. 1 illustrates an example networked computing system 100 according to an embodiment of this disclosure. As depicted, system 100 includes a data communications network 102, one or more base stations 106a-e, one or more base station antennas 104a-e, one or more network controller devices 110a-c, and one or more User Equipment (UE) 108a-m. As used herein, the term “base station” refers to a wireless communications station provided in a location and serves as a hub of a wireless network. The base stations include macrocells, microcells, picocells, and femtocells. The term “network control device” refers to a device that manages the resources of a network. The network control devices include Network Resource Controllers (NRCs), where the NRCs include conventional NRCs and self-organizing network (SON) controllers that can perform self-configuration, self-optimization and/or self-healing. The term “user equipment” refers to any device used directly by an end-user. The user equipment includes mobile phones, laptop computers, tablets, hand-held electronic devices with wireless communication capabilities, or the like. The terms such as “mobile station,” “mobile device,” “subscriber device,” “subscriber,” or the like, are used interchangeably with the term “user equipment.”

In system 100, the data communications network 102 may include a backhaul portion that can facilitate distributed network communications between any of the network controller devices 110 a-c and any of the base stations 106a-e. Any of the network controller devices 110a-c may be a dedicated NRC that is provided remotely from the base stations or provided at the base station. Any of the network controller devices 110a-c may be a non-dedicated device that provides NRC functionality among others. The one or more UE 108a-m may include cell phone devices 108a-i, laptop computers 108j-k, handheld gaming units 1081, electronic book devices or tablet PCs 108m, and any other type of common portable wireless computing device that may be provided with wireless communications service by any of the base stations 106a-e.

As would be understood by those skilled in the Art, in most digital communications networks, the backhaul portion of a data communications network 102 may include intermediate links between a backbone of the network which are generally wire line, and sub networks or base stations 106a-e located at the periphery of the network. For example, cellular user equipment (e.g., any of UE 108a-m) communicating with one or more base stations 106a-e may constitute a local sub network. The network connection between any of the base stations 106a-e and the rest of the world may initiate with a link to the backhaul portion of an access provider's communications network 102 (e.g., via a point of presence).

In an embodiment, an NRC (such as a SON controller) has presence and functionality that may be defined by the processes it is capable of carrying out. Accordingly, the conceptual entity that is the NRC may be generally defined by its role in performing processes associated with embodiments of the present disclosure. Therefore, depending on the particular embodiment, the NRC entity may be considered to be either a hardware component, and/or a software component that is stored in the computer readable media such as volatile or non-volatile memories of one or more communicating device(s) within the networked computing system 100.

In an embodiment, any of the network controller devices 110a-c and/or base stations 106a-e may function independently or collaboratively to implement any of the processes associated with various embodiments of the present disclosure. Further, any of the processes for reducing interference may be carried out via any common communications technology known in the Art, such as those associated with modern Global Systems for Mobile (GSM), Universal Mobile Telecommunications System (UMTS), Long Term Evolution (LTE) network infrastructures, etc.

In accordance with a standard GSM network, any of the network controller devices 110a-c (NRC devices or other devices optionally having NRC functionality) may be associated with a base station controller (BSC), a mobile switching center (MSC), or any other common service provider control device known in the art, such as a radio resource manager (RRM). In accordance with a standard UMTS network, any of the network controller devices 110a-c (optionally having NRC functionality) may be associated with a network resource controller (NRC), a serving GPRS support node (SGSN), or any other common network controller device known in the art, such as a radio resource manager (RRM). In accordance with a standard LTE network, any of the network controller devices 110a-c (optionally having NRC functionality) may be associated with an eNodeB base station, a mobility management entity (MME), or any other common network controller device known in the art, such as an RRM.

In a wireless network, the number of UEs attached to a particular base station is a function of the number of active users in the base station's coverage area. If a large number of users are closer to a particular base station than its neighbors, the particular base station may have a larger number of UEs attached to it than its neighbors do, even though some of the UEs are within service range of the neighboring base stations. For example, with reference to elements of FIG. 1, base station 106a has fewer active attached UE than neighboring base stations 106b and 106e.

In an embodiment, any of the network controller devices 110a-c, the base stations 106a-e, as well as any of the UE 108a-m may be configured to run any well-known operating system, including, but not limited to: Microsoft® Windows®, Mac OS®, Google® Chrome®, Linux®, Unix®, or any mobile operating system, including Symbian®, Palm®, Windows Mobile®, Google® Android®, Mobile Linux®, etc. Any of the network controller devices 110a-c, or any of the base stations 106a-e may employ any number of common server, desktop, laptop, and personal computing devices.

In an embodiment, any of the UE 108a-m may be associated with any combination of common mobile computing devices (e.g., laptop computers, tablet computers, cellular phones, handheld gaming units, electronic book devices, personal music players, MiFi™ devices, video recorders, etc.), having wireless communications capabilities employing any common wireless data communications technology, including, but not limited to: GSM, UMTS, 3GPP LTE, LTE Advanced, WiMAX, etc.

In an embodiment, the backhaul portion of the data communications network 102 of FIG. 1 may employ any of the following common communications technologies: optical fiber, coaxial cable, twisted pair cable, Ethernet cable, and power-line cable, along with any other wireless communication technology known in the art. In context with various embodiments of the invention, it should be understood that wireless communications coverage associated with various data communication technologies (e.g., base stations 106a-e) typically vary between different service provider networks based on the type of network and the system infrastructure deployed within a particular region of a network (e.g., differences between GSM, UMTS, LTE, LTE Advanced, and WiMAX based networks and the technologies deployed in each network type).

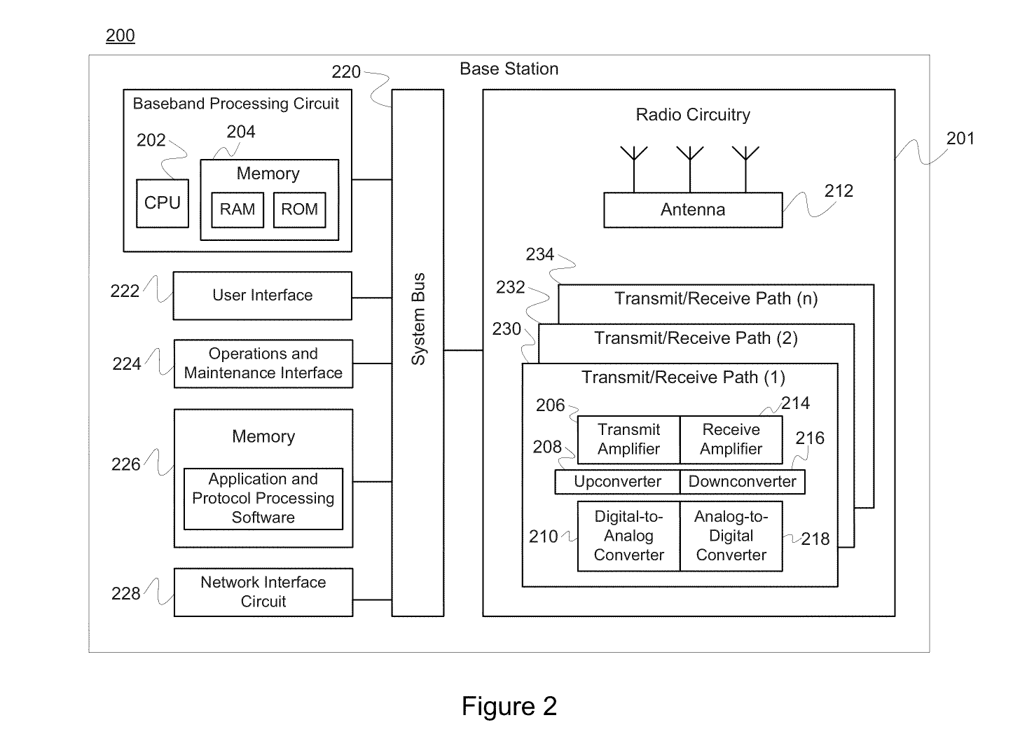

FIG. 2 illustrates a block diagram of a base station 200 (e.g., a femtocell, picocell, microcell or macrocell) that may be representative of the base stations 106a-e in FIG. 1. In an embodiment, the base station 200 includes a baseband processing circuit including at least one central processing unit (CPU) 202. The CPU 202 may include an arithmetic logic unit (ALU, not shown) that performs arithmetic and logical operations and one or more control units (CUs, not shown) that extract instructions and stored content from memory and then executes and/or processes them, calling on the ALU when necessary during program execution. The CPU 202 is responsible for executing computer programs stored on volatile (RAM) and nonvolatile (ROM) system memories 204.

The base station 200 includes radio circuitry 201 for transmitting and receiving data to and from the network. The radio circuitry 201 may include a transmit path including a digital-to-analog converter 210 for converting digital signals from a system bus 220 into analog signals to be transmitted, an upconverter 208 for setting the frequency of the analog signal, and a transmit amplifier 206 for amplifying analog signals to be sent to the antenna 212 and transmitted as signals. In addition, the radio circuitry 201 may include a receive path including the receive amplifier 214 for amplifying signals received by the antenna 212, a downconverter 216 for reducing the frequency of the received signals, and an analog-to-digital converter 218 for outputting the received signals onto the system bus 220. The system bus 220 facilitates data communication amongst the hardware resources of the base station 200. There may be any number of transmit/receive paths 230, 232, and 234 comprising multiple digital-to-analog converters, upconverters, and transmit amplifiers as well as multiple analog-to-digital converters, downconverters, and receive amplifiers according to implementation. Additionally, antenna 212 may include multiple physical antennas for transmitting beamformed communications.

The base station 200 may also include a user interface 222, an operations and maintenance interface 224, memory 226 storing application and protocol processing software, and a network interface circuit 228 facilitating communication across the LAN and/or WAN portions of a backhaul network (e.g., data communications network 102 in FIG. 1).

In an embodiment, the base station 200 may use any modulation/encoding scheme known in the art such as Binary Phase Shift Keying (BPSK, having 1 bit/symbol), Quadrature Phase Shift Keying (QPSK, having 2 bits/symbol), and Quadrature Amplitude Modulation (e.g., 16-QAM, 64-QAM, etc., having 4 bits/symbol, 6 bits/symbol, etc.). Additionally, the base station 200 may be configured to communicate with UEs 108a-m via any Cellular Data Communications Protocol, including any common GSM, UMTS, WiMAX or LTE protocol.

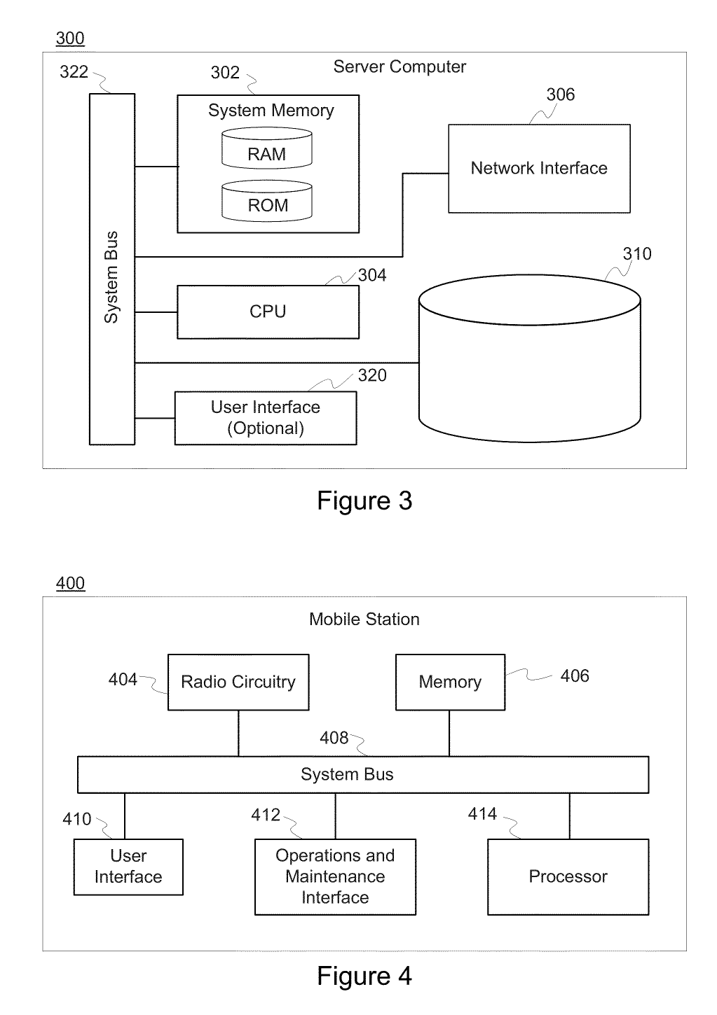

FIG. 3 illustrates a block diagram of a server computer 300 that may be representative of any of the network controller devices 110a-c. In an embodiment, one or more of the network controller devices 110a-c are SON controllers. The server computer 300 includes one or more processor devices including a central processing unit (CPU) 304. The CPU 304 may include an arithmetic logic unit (ALU) (not shown) that performs arithmetic and logical operations and one or more control units (CUs) (not shown) that extracts instructions and stored content from memory and then executes and/or processes them, calling on the ALU when necessary during program execution. The CPU 304 is responsible for executing computer programs stored on volatile (RAM) and nonvolatile (ROM) memories 302 and a storage device 310 (e.g., HDD or SDD).

The server computer 300 may also include an optional user interface 320 that allows a server administrator to interact with the server computer's software and hardware resources and to display the performance and operation of the networked computing system 100. In addition, the server computer 300 may include a network interface 306 for communicating with other components in a networked computer system, and a system bus 322 that facilitates data communications amongst the hardware resources of the server computer 300.

In addition to the network controller devices 110a-c, the server computer 300 may be used to implement other types of server devices, such as an antenna controller, an RF planning engine, a core network element, a database system, or the like. Based on the functionality provided by a server computer, the storage device of such a server computer serves as a repository for software and database thereto. For example, if the network controller device 110 is implemented, the storage device 310 may include a phase adjustment map having a listing of adjacent wireless base stations and their instantaneous transmission phase adjustments, a scheduling unit for generating a CPE phase management table for transmitting data to mobile stations associated with the server computer or base station, a beamforming unit for generating the beamformed signals for transmission to a particular mobile station, and a priority fixing unit for determining a priority level for interference associated with an adjacent interfering base station.

FIG. 4 illustrates a block diagram of a mobile station 400 that may be representative of any of UEs 108 shown in FIG. 1. The mobile station 400 may include components similar to those described above in relation to the base station 200. The mobile station 400 may include radio circuitry 404 corresponding to the radio circuitry in FIG. 2, a memory 406 corresponding to the memory 226, a system bus 408 corresponding to system bus 220, a user interface 410 corresponding to user interface 222, an operations and maintenance interface 412 corresponding to the operations and maintenance interface 224, and a processor (or CPU) 414.

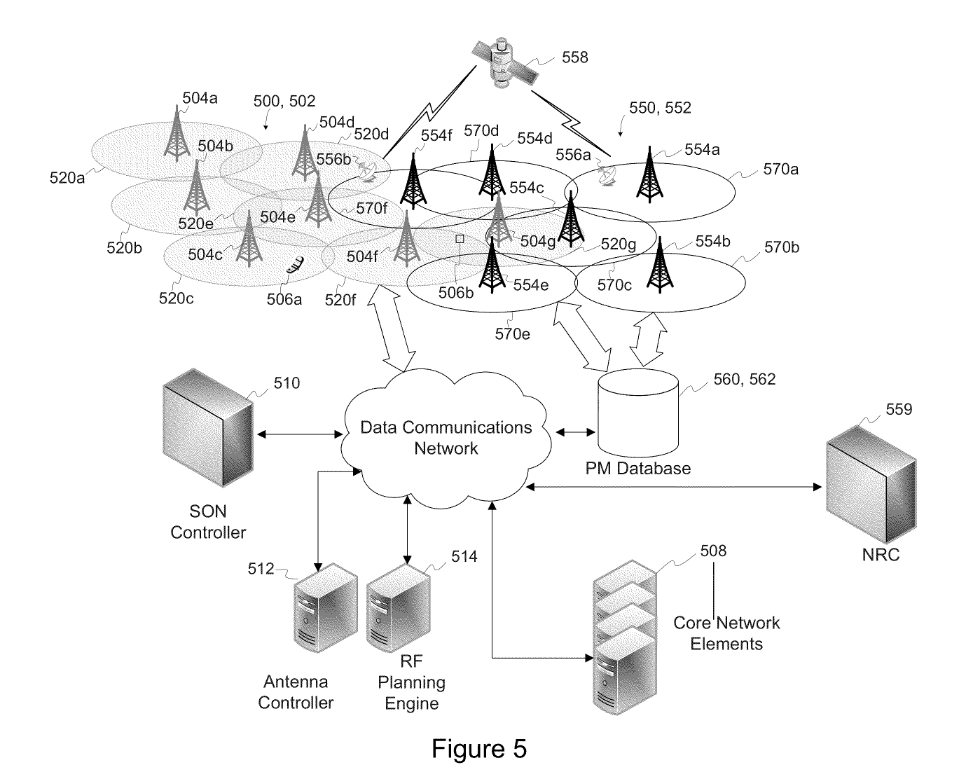

FIG. 5 illustrates first and second networked computer systems 500 and 550 including a first wireless network 502 and a second wireless network 552, respectively, according to an embodiment. The first and second wireless networks 502 and 550 provide services in overlapping geographic regions and may use frequency bands that overlap each other. In another embodiment, the frequencies do not overlap but are sufficiently close to cause interference when used at the same time, e.g., wireless signals transmitted by devices in the first wireless network 502 can cause interference to wireless receivers in the second wireless network 552. Frequencies that interfere with each other due to the close proximity are refer to as “adjacent frequencies” or “nearby frequencies.” Accordingly, regulatory bodies typically allocates to network operators frequency bands that are sufficiently spaced apart from other frequency bands in order to prevent interference between these different networks. The frequency separation between the frequency bands allocated to networks depends on a number of factors, including the relative transmit power of transceiver devices in each network, the required receiver sensitivity of devices in each network, the types of antennas used in each network (i.e., directional antennas vs. omni-directional antennas and the uplink/downlink duplexing technologies used in each network (e.g., Time Division Duplexing (TDD) and Frequency Division Duplexing (FDD)). Frequency separation can vary from a few hundred kilohertz when the two networks have similar characteristics to several tens of Megahertz when the two networks have very different characteristics (e.g., the first network is a FDD network with transmit power in the range of 100 W (50 dBm) per base station and a receiver sensitivity of −104 dBm, while the second network is a TDD system with receiver sensitivities of −160 dBm). An example of two frequency bands which use frequencies that do not overlap but are sufficiently close to cause interference between systems deployed in those frequencies is the frequency band 1525-1559 MHz for which a terrestrial 4G-LTE cellular wireless broadband network has been proposed and the 1559-1610 MHz band used by Global Positioning System (GPS). Another example of wireless networks where transmission in non-overlapping but adjacent frequencies causes interference is FM radio networks: transmissions separated by 200 KHz can cause interference with transmissions on neighboring frequencies.

The first networked computer system 500 includes a plurality of base stations 504a-g that provide wireless services to subscriber devices 506a-b. The base stations 504a-g have coverage areas 520a-g, respectively. These coverage areas (or cell areas) 520a-g define the geographic areas where the first wireless network 502 provides wireless communication services. A core network 508 provides switching, routing and transit for data traffic. A SON controller 510 implements and executes SON processes, as explained in more detail below, for the first networked computer system 502. An antenna controller 512 controls antenna parameters like azimuth, tilt, and height for the antennas of the base stations 504a-g. An RF planning engine 514 is used to optimally provide services to the subscriber devices, which includes selecting new site locations for base stations and determining appropriate RF settings and other parameters for base stations already deployed. For example, the SON controller 510 can communicate with the RF planning engine 514 to estimate the impact of changing the antenna pointing directions.

Although FIG. 5 illustrates a single SON controller 510, the functionality of the SON controller 510 may be distributed across multiple nodes in the network. For example, portions of the SON processes may be executed at each of the base stations 504a-g and the SON processes may communicate data amongst the base stations in order to accomplish the desired SON functionality.

According to implementation, the first wireless network 502 may be a standards based communications network, e.g., GSM, UMTS, LTE, WiFi, etc., or a proprietary network. Alternatively, the first wireless network 502 may consist of a mix of standards based technology (e.g., a wireless network that supports LTE, UMTS and GSM technologies).

The second wireless network 552 includes base stations 554a-f, ground-based transceivers 556a-b, a satellite 558, airborne transceivers (not shown), ground-based or air-based radar (not shown), an NRC 559, and other components. The base stations 554a-f have coverage areas 570a-g, respectively. The transceivers 556a-b, the satellite 558, and other components have their own coverage areas. These coverage areas (or cell areas) define the geographic areas where the second wireless network 552 provides wireless communication services. The ground-based transceivers 556a-b may be capable of communicating with the base stations 554a-f, with the satellite 558 or with other transceivers that are part of the second wireless network 552. Performance data for the second wireless network 552 may be stored in a performance metrics database 560 in a storage system 562, e.g., a server. Examples of metrics data stored in the performance metrics database 560 include: (1) measurements of the utilization of each of the nodes and wireless links in the second wireless network, (2) measurements of interference seen at nodes throughout the second wireless network, (3) measurements of signal quality seen at nodes throughout the second wireless network, (4) measurements of error rates in the wireless communications links of the second wireless network, (5) topology information from the second wireless network, (6) handover data and handover measurements made in the second wireless network, and the like.

In an embodiment, the first wireless network 502 provides services to one group of subscribers, and the second wireless network 550 provides services to a second group of subscribers. An example of the first wireless network 502 is a cellular network that provides voice and data services to subscribers. An example of the second wireless network 550 is a cellular network that provides voice and data services to subscribers but uses a different cellular technology or is owned by a different company. Another example of the second wireless network 550 is a network that provides wireless services for public safety, aviation, military, or other government-related matters. Such a governmental-related wireless network only use a small fraction of its available capacity, e.g., 5% or less. Accordingly, much of wireless communication capacity allocated to the second wireless network 552 remains unused. This underutilization of the frequency bands allocated to the second wireless network 552 results in an inefficient usage of an important resource in this age of radio spectrum scarcity.

In an embodiment, the first wireless network 502 is configured to use a block of frequency spectrum (or a first frequency band) that is the same, overlapping, or adjacent to a block of frequency spectrum (or a second frequency band) used by the second wireless network so that the available frequency spectrum can be more efficiently utilized by the wireless network operators. However, since coverage areas of the first and second wireless networks 502 and 552 may overlap, the signal interference is a concern when the same, overlapping, or adjacent frequency bands are used by the first and second wireless networks 502 and 552. The transmissions made on the first wireless network 502 may cause issues for signal reception in the second wireless network 552, e.g., if harmonics or inter-modulation products of signals transmitted in the first wireless network are at the same frequencies as signals transmitted and received in the second wireless network. Similarly, high power signals transmitted by the first wireless network 502 may result in overloading or saturation of the RF front end of sensitive radio receivers of the second wireless network 552.

In an embodiment, the SON controller 510 is used to address the interference concerns between the first and second wireless network 502 and 552. The SON controller 510 obtains and uses performance metrics data gathered from the second wireless network 552 to configure the first wireless network 502 in order to reduce its interference effects on the second wireless network 552. With the effective use of the SON controller 510 (or SON processes), the first wireless network 502 may use a frequency that is the same, overlapping, or adjacent to that used by the second wireless network 552.

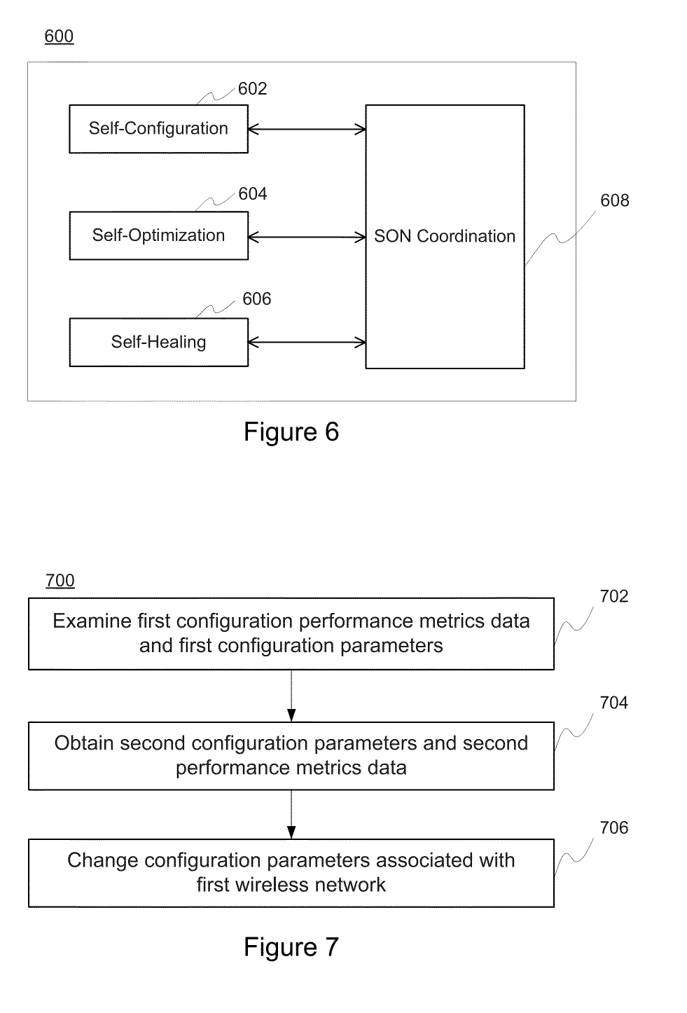

FIG. 6 illustrates a SON controller 600 that may be representative of the SON controller 510 according to an embodiment. The SON controller 600 includes a number of modules that performs the SON processes by first gathering data from one or more wireless networks, such as network element IDs, performance metrics, and the like. The SON processes use these data to make decisions on how to make appropriate changes to the network in an automated fashion. These changes can then be either automatically applied to the network (closed loop SON) or first reviewed by a human operator who makes the final decision as to whether or not these changes should be applied to the network (open loop SON).

The SON controller 600 includes a self-configuration module 602 that configures newly deployed base stations (or nodes). A self-optimization module 604 uses the performance measurements of the wireless networks including UE and base station measurements to auto-tune the first wireless network 502. In an embodiment, the self-optimization module 604 changes configuration parameters (or “parameters”) of the first network so that interference generated by the first network towards the second network is reduced. The self-optimization module 604 uses measurements that are made by elements of the second wireless network 552 as wells as those made by elements of the first wireless network 502 as part of the optimization process. Parameters of the first wireless network that may be changed include: bulk transmit power of radio transmitters, transmit power settings of individual radio resources (e.g., transmit power of a wireless sub band, or transmit power used on different timeslots or on different radio codes, pointing direction of remotely controlled antennas (e.g., antennas with remote electrical tilt (RET), remote azimuth steering (RAS) or remote azimuth beam width (RAB) capabilities), and the like. In an embodiment, the SON processes optionally may communicate recommended parameter changes to the NRC 559 of the second wireless network for configuration change by the second wireless network 552.

The SON controller 600 also includes a self-healing module 606 to automatically detect the failures in the elements of the first wireless network 502 and apply self-healing mechanisms to solve these failures, e.g., reducing the output power in case of temperature failure or automatic fallback to a previous software version. A SON coordination module 608 communicates with the self-configuration, self-optimization, and self-healing modules 602, 604, and 606 to implement the SON processes.

FIG. 7 illustrates a process 700 for reducing interference between the first and second wireless networks 502 and 552 having overlapping geographic coverage areas according to an embodiment. In an implementation, the first wireless network 502 is a standards based cellular network owned and operated by a cellular network operator providing services to the general public while the second wireless network 552 is a public safety network owned and operated by a government entity, or a network used for military purposes. In another implementation, the first wireless network 502 and the second wireless network 552 are both standards based cellular networks that are owned and operated by separate operators. In yet another implementation, the first wireless network and the second wireless network may be owned and operated by the same network operator, but each network may be based on different technologies.

Although the first and second wireless networks 502 and 552 are based on different technologies or operated by different entities, the process 700 is directed to SON processes that change the configuration of the first wireless network 502 taking into consideration the potential impact such changes would have on the second wireless network 552.

Although the process 700 is explained using a single SON controller 510, the functionality of the SON controller 510 may be distributed across multiple nodes in the network. For example, portions of the SON processes may be executed at each of the base stations 504a-g and the SON processes may communicate data amongst the base stations in order to accomplish the desired SON functionality.

The process 700 is explained using FIGS. 5 and 6 for illustrative convenience, but it may be implemented in various other wireless environments. The process 700 may be initiated based on an event notification or a predetermined schedule. The event notification may be triggered by a detection of interference at the second wireless network 552. The detection may be performed by the SON controller 510 or an element in the second wireless network 552. At 702, the SON controller 510 examines first performance metrics data and first configuration parameters of the first wireless network 502. In certain implementations, the SON controller 510 may examine only the first configuration parameters. At 704, the SON controller 510 obtains second performance metrics data and second configuration parameters of the second wireless network 552. In certain implementations, the SON controller 510 may obtain only the second performance metrics data. At 706, the SON controller 510 changes a parameter or set of parameters associated with the first wireless network 502 based on the first and second performance metrics data and the first and second configuration parameters. In certain implementation, the SON controller 510 may change a parameter or set of parameters associated with the first wireless network 502 based on only the first configuration parameters and the second performance metrics data (i.e., without using the first performance metrics data and the second configuration parameters). The parameters are changed with the intent of reducing interference experienced by the second wireless network 552.

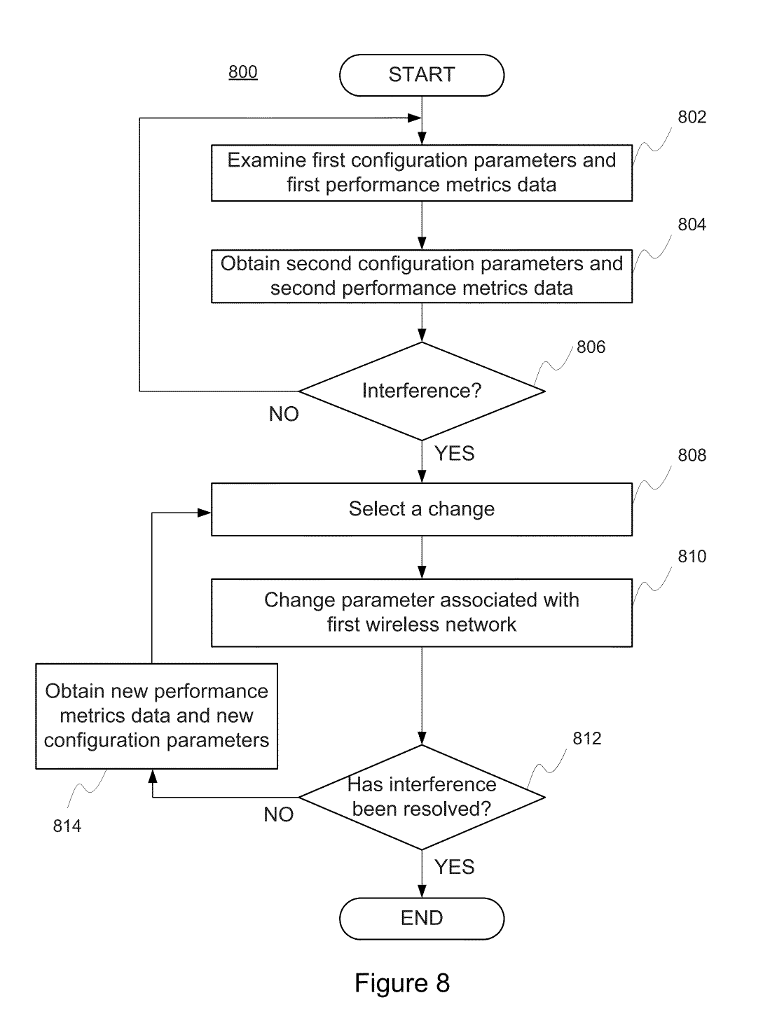

FIG. 8 illustrates a process 800 for reducing interference between the first and second wireless networks 502 and 552 having overlapping geographic coverage areas according to an embodiment. In an implementation, as explained above in connection with the process 700, the first and second wireless networks may be based on different technologies or operated by different entities. The process 800 is directed to SON processes that change the configuration of the first wireless network 502 taking into consideration the potential impact such changes would have on the second wireless network 552.

Although the process 800 is explained using a single SON controller 510, the functionality of the SON controller 510 may be distributed across multiple nodes in the network. For example, portions of the SON processes may be executed at each of the base stations 504a-g and the SON processes may communicate data amongst the base stations in order to accomplish the desired SON functionality.

The process 800 is explained using FIGS. 5 and 6 for illustrative convenience, but it may be implemented in various other wireless environments. The process 800 may be initiated based on an event notification or a predetermined schedule. At 802, the SON controller 510 examines first performance metrics data and first configuration parameters of the first wireless network 502. In certain implementations, the SON controller 510 may examine only the first configuration parameters. In an implementation, the process 800 is executed based on a predetermined schedule. Examples of the first configuration parameters include:
transmission power at each node (or base station) in the first wireless network
pointing direction of antenna at each node in the first wireless network
topology information from the first wireless network
   Examples of the first performance metrics data include:
measurements of the utilization of wireless resources of each of the nodes and wireless links in the first wireless network,
measurements of interference seen at nodes throughout the first wireless network
measurements of signal quality seen at nodes throughout the first wireless network,
measurements of error rates in the wireless communications links of the first wireless network
handover data and handover measurements made in the first wireless network,
measurements of the amount of data transmitted by each of the nodes in the first wireless network
measurements of the amount of data received by each of the nodes in the first wireless network
measurements of the number of successful and failed attempts at network attachment by devices of the first wireless network
measurements of the number of dropped connections in the first wireless network

At 804, the SON controller 510 obtains second performance metrics data and the second configuration parameters from the second wireless network 552. The SON controller 510 of the first wireless network may obtain the second performance metrics data and the second configuration parameters from the performance metrics database 562 or directly from elements (e.g., base stations or other transceiver devices) in the second wireless network 552. In certain implementations, the SON controller 510 may obtain only the second performance metrics data. In an embodiment, the second wireless network 552 is a network that typically provide services to different subscribers than the first wireless network 502. For example, the first wireless network 502 is a cellular network that provides voice and data services to subscribers, and the second wireless network 552 is a network that provides wireless services for public safety, aviation, military, or other government-related matters. In an embodiment, the SON controller 510 obtains the second performance metrics data from the second wireless network 552 in order to take into consideration on the potential impact these changes to the configuration of the first wireless network 502 would have on the second wireless network 552.

In an embodiment, the SON controller 510 have access to data in the performance metrics database 562 that contains metrics data collected by or from the second wireless network 552. The access may be via an interface (not shown) into the performance metrics database 562, or may be via data received from the NRC 572 of the second wireless network 552. Examples of metrics data stored in the performance metrics database 562 include: (1) measurements of the utilization of each of the nodes and wireless links in the second wireless network, (2) measurements of interference seen at nodes throughout the second wireless network, (3) measurements of signal quality seen at nodes throughout the second wireless network, (4) measurements of error rates in the wireless communications links of the second wireless network, (5) handover data and handover measurements made in the second wireless network, and the like. The performance metrics database 562 may also include the second configuration parameters (e.g., topology information from the second wireless network) that may be accessible by the SON controller 510. Depending on implementation, the SON controller 510 may be permitted to access only the second performance metrics data, and not the second configuration parameters.

At 806, it is determined whether or not the second wireless network is experiencing an interference from the first wireless network. If not, the process 800 waits to execute step 802 at the next scheduled time or next event notification. If interference is detected, the process proceeds to the next step. In an implementation, the identifying step 806 may be performed by the NRC 559 of the second wireless network 552 and alerts the SON controller 510 to execute the process 800.

At 808, the SON controller 510 selects a change to the first wireless network 502 that would be expected to effectively resolve the interference experienced by the second wireless network 552. The SON controller 510 selects the change based on the first and second performance metrics data and the first and second configuration parameters. Depending on implementation, the SON controller 510 may select the change based on only the first configuration parameters and the second performance metrics data (i.e., without using the first performance metrics data and the second configuration parameters). In an embodiment, the SON controller 510 may select the change based on the information on the expected impact received from the RF planning engine 514. The RF planning engine 514 helps the SON controller 510 estimate the impact of changing various parameters of the first wireless network 502 on the first wireless network itself and on the neighboring second wireless network. For example, if the first and second performance metrics data indicates that the base station 554c of the second wireless network 552 is experiencing interference from the base station 504g of the first wireless network 502, the SON controller 510 can change the antenna pointing direction of the base station 504g in order to reduce inference experienced by the base station 554c. Alternatively, the SON controller 510 can reduce transmission power of the base station 504g to eliminate the interference experienced by the base station 554c. In order to compensate for the reduction of the coverage area of the base station 554c, the SON controller 510 may also increase the transmission power of the base station 504f.

At 810, the SON controller 510 changes a parameter or set of parameters associated with the first wireless network 502 based on the change selected at 808. For example, the SON controller 510 instructs the antenna controller 512 to change the antenna pointing direction of an antenna in the first wireless network 502 if the change selected at 808 is changing the antenna pointing direction of an antenna in the first wireless network.

At 812, the SON controller 510 determines if the interference has been resolved. If resolved, the process 800 ends. If not, new first and second performance metrics data and new first and second configuration parameters are obtained (814) and the steps 808 and 810 are repeated. Alternatively, only the new second performance metrics data may be obtained. In an implementation, the SON controller 510 may first collect the new performance metrics data in order to make a determination whether or not the interference has been resolved.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting.

What is claimed is:

1. A network resource device associated with a first wireless network that is configured to provide wireless services in a first geographic area, the network resource device comprising:
a processor; and
a non-transitory computer readable medium with computer executable instructions stored thereon which, when executed by the processor, perform the following method:
obtaining performance metrics data of a second wireless network, the second wireless network being configured to provide wireless communication services in a second geographic area that overlaps with the first geographic area; and
changing a configuration parameter associated with the first wireless network based on the second performance data obtained in order to reduce interference generated by the first wireless network towards the second wireless network.

2. The network resource device of claim 1, wherein the first wireless network uses a first frequency band that is the same as or overlapping a second frequency band used by the second wireless network, and
wherein the network resource device is provided with configuration parameters of the first wireless network for use in changing the configuration parameter of the first wireless network.

3. The network resource device of claim 2, wherein the first wireless network and the second wireless network are operated by different network operators.

4. The network resource device of claim 3, wherein the second wireless network is operated by a government agency.

5. The network resource device of claim 3, wherein the method further comprises:
receiving an indication of interference occurring at a node in the second wireless network;
determining whether or not the interference at the node in the second wireless network is resolved by changing the configuration parameter associated with the first wireless network; and
if it is determined that the interference at the node in the second wireless network is not resolved by changing the configuration parameter, changing the same configuration parameter or a different configuration parameter, or both.

6. The network resource device of claim 1, wherein a frequency band of the first wireless network and a second frequency band of the second wireless network are adjacent frequency bands that are sufficiently close in radio spectrum to cause interference with each other.

7. The network resource device of claim 1, wherein a frequency band of the first wireless network and a second frequency band of the second wireless network are adjacent frequency bands that are sufficiently close in radio spectrum to cause interference with each other,
wherein the first wireless network and the second wireless network are operated by different network operators, and
wherein the method further comprises:
receiving an indication of interference occurring at a node in the second wireless network,
determining whether or not the interference at the node in the second wireless network is resolved by changing the configuration parameter associated with the first wireless network, and
if it is determined that the interference at the node in the second wireless network is not resolved by changing the configuration parameter, changing the same configuration parameter or a different configuration parameter, or both,
wherein the network resource device is provided with configuration parameters and performance metrics data of the first and second wireless networks.

8. The network resource device of claim 1, wherein the configuration parameter changed is transmit power of a radio transmitter in the first wireless network or pointing direction of an antenna in the first wireless network.

9. The network resource device of claim 1, wherein the network resource device is a self-organizing network controller for the first wireless network.

10. The network resource device of claim 1, wherein the network resource device is provided at a location remote from any of base stations of the first wireless network, or at one or more of the base stations of the first wireless network.

11. A method for reducing interference in a wireless network, the method comprising:
accessing configuration parameters of a first wireless network by a network resource device associated with the first wireless network, the first wireless network being configured to provide wireless communication services in a first geographic area;
obtaining performance metrics data of a second wireless network by the network resource device, the second wireless network being configured to provide wireless communication services in a second geographic area that overlaps with the first geographic area; and
changing a configuration parameter associated with the first wireless network by the network resource device based on the performance metrics data of the second wireless network in order to reduce interference generated by the first wireless network towards the second wireless network.

12. The method of claim 1, wherein the first wireless network uses a first frequency band that is the same as or overlapping a second frequency band used by the second wireless network, and
wherein the first wireless network and the second wireless network are operated by different network operators.

13. The method of claim 12, further comprising:
receiving an indication of interference occurring at a node in the second wireless network;
determining whether or not the interference at the node in the second wireless network is resolved by changing the configuration parameter associated with the first wireless network; and
if it is determined that the interference at the node in the second wireless network is not resolved by changing the configuration parameter, changing the same configuration parameter or different configuration parameter, or both.

14. The method of claim 11, wherein a frequency band of the first wireless network and a second frequency band of the second wireless network are adjacent frequency bands that are sufficiently close in radio spectrum to cause interference with each other.

15. The method of claim 11, wherein a frequency band of the first wireless network and a second frequency band of the second wireless network are adjacent frequency bands that are sufficiently close in radio spectrum to cause interference with each other,
wherein the first wireless network and the second wireless network are operated by different network operators, and
wherein the method further comprises:
receiving an indication of interference occurring at a node in the second wireless network,
determining whether or not the interference at the node in the second wireless network is resolved by changing the configuration parameter associated with the first wireless network, and
if it is determined that the interference at the node in the second wireless network is not resolved by changing the configuration parameter, changing the same configuration parameter or different configuration parameter, or both,
wherein the network resource device is provided with configuration parameters and performance metrics data of the first and second wireless networks.

16. The method of claim 1, wherein the network resource device is a self-organizing network controller for the first wireless network.

17. A networked computing system, comprising:
a first wireless network having a plurality of base stations, the first wireless network being configured to provide wireless services in a first geographic coverage area that overlaps with a second geographic coverage area of a second wireless network;
a network resource device associated with the first wireless network; and
a non-transitory computer readable medium provided in an element in the first wireless network, the non-transitory computer readable medium having computer executable instructions stored thereon which, when executed by the processor, perform the following method:
accessing configuration parameters associated with the first wireless network; and
changing a configuration parameter associated with the first wireless network based on performance metrics data of the second wireless network in order to reduce interference generated by the first wireless network towards the second wireless network.

18. The network computing system of claim 17, wherein the method further comprising:
receiving an indication of interference at a node in the second wireless network,
wherein the non-transitory computer readable medium is provided in the network resource device.

19. The network computing system of claim 18, wherein the indication of the interference is based on performance metrics data of the second wireless network received by network resource device.

20. The network computing system of claim 17, wherein the first wireless network uses a first frequency band that is the same as, overlapping, or adjacent to a second frequency band used by the second wireless network, and
wherein the first wireless network and the second wireless network are operated by different network operators.
